(19) United States
(12) Patent Application Publication
(10) Pub. No.: US 2016/0042371 A1
(43) Pub. Date: Feb. 11, 2016

(54) SYSTEMS AND METHODS FOR INFLUENCING CUSTOMER TREATMENT IN A CONTACT CENTER THROUGH DETECTION AND ANALYSIS OF SOCIAL MEDIA ACTIVITY

(71) Applicant: Avaya Inc., Santa Clara, CA (US)

(72) Inventor: Reinhard Klemm, Basking Ridge, NJ (US)

(73) Assignee: AVAYA INC., Santa Clara, CA (US)

(21) Appl. No.: 14/452,472

(22) Filed: Aug. 5, 2014

(51) Int. Cl. G06Q 30/02

(52) U.S. Cl. CPC G06Q 30/0203; G06Q 50/01

(57) ABSTRACT

A contact center is operated, on behalf of an entity, by reference to social media analytics. A user profile, acquired for each of a plurality of social media users, identifies the user and includes at least one of three indications of sentiment derived over time through analysis of social media event activities and/or behavior. The sentiment indications of a profile include user sentiment toward the entity, user sentiment toward one or more competitor(s) of the entity, and/or user sentiment toward a particular product or service offered by the entity or a competitor(s) of the entity. A communication session is established between a communication terminal of a contact center agent and one of the users for whom a user profile is stored. A menu including at least one option for addressing or capitalizing on a change of sentiment reflected in the user's profile is displayed to the agent.

### BACKGROUND OF THE INVENTION

1. Field of the Invention

Embodiments of the present invention generally relate to customer relationship management and, more particularly, to systems and methods for managing the timing and/or conduct of interactions between contact center agents and customers or potential customers of an entity.

2. Description of the Related Art

Information relating to if, when and/or why a company's customers (or potential customers) have become more (or less) interested in or receptive to the products of the company or of a competitor is highly prized. Information of particular interest to a company is the timing of a change or shift in sentiment, and whether that change is correlated with publicized events at this company or a competitor (e.g., a new product launch or a price increase for a product), news or revelations from or about this company or a competitor (such as a lawsuit against the company or an award for a company product), company announcements (e.g., an intent to acquire a competitor), or “viral” customer criticism of or approbation for the company's conduct or a competitor's conduct.

Traditionally, measurements of brand loyalty and customer sentiment are available through probability-based market research. By reference to census data, for example, a market research team identifies a sample of the target population and conducts surveys, at regular intervals, to track changes and shifts in such measures of customer sentiment as brand or company loyalty. The two methods most frequently used in market research are probability sampling and non-probability sampling. One difference between these two methods is that in probability sampling, all members of a population are presumed to have a chance of being selected, and the results of a survey are thus more likely to accurately reflect the sentiments of that entire population.

The regular performance of market surveys can provide valuable insights to any organization, especially when it comes to designing and assessing the effectiveness of a marketing campaign. However, they are expensive and time consuming to carry out, and they also lack the kind of granularity needed to identify the specific causes of a change or shift in customer sentiment. Moreover, such insights are of little use in a contact center environment wherein contact center agents are entrusted with the task of accessing information collected from or about a company's customers (or prospective customers) and using that information in order to develop, strengthen, and/or preserve a relationship between the customer and the company.

A continuing need therefore exists for systems and techniques enabling customer relationship managers and/or the agents of a contact center to more effectively identify changes in customer sentiment, and to take prompt and effective action in response to those changes.

### SUMMARY OF THE INVENTION

The Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A method for aiding contact center agents in the management of an entity's relationships with one or more customers and/or potential customers, by reference to dynamically variable social media activities indicative of publicly expressed sentiment, is described. According to one or more embodiments, a user profile is compiled or otherwise acquired for each of a plurality of social media users. In some embodiments, each user profile includes an identification of one of the users as well as at least one of three indications of sentiment collected over time and derived from social media activities. The sentiment indications of a profile include user sentiment toward the entity, user sentiment toward a competitor of the entity, and/or user sentiment toward a particular product or service offered by the entity or a competitor of the entity.

In one more embodiment, the sentiment indications comprise scores based on a volume of social media activity indicative of loyalty to the entity or a competitor of the entity and/or to one of their respective products or services. In other embodiments, pre-defined key words and phrases are used to perform sentiment analysis, and in still other embodiments, volume of activity are correlated to one or more predefined event windows such, for example, as an announcement of a product launch, a bug fix, or a product vulnerability by the entity or one of its competitors. In yet other embodiments, changes in profiled user attentiveness towards or away from social network site(s) associated with the entity (its own social network pages) at the expense of, or in favor of, respectively, site(s) associated with one of a set of predefined competitors are characterized as “user migrations” representative of a change in sentiment. According to one or more embodiments, shifts and patterns of profiled user sentiment and/or site attentiveness are identified and connections to contact center agents or customer relation management personnel are initiated for pro-active response. In other embodiments, a customer contacting an entity may receive details of special offers intended to preserve an old relationship or deepen a nascent one.

In some embodiments, the social media activities of entire customer subpopulations are analyzed during a given timeframe. Such analysis can be in furtherance of the purpose of improving/strengthening relationships with customers or prospective customers. In some embodiments, an entire subpopulation receives a “profile”, and the profile contains information which when viewed at the display of a contact center agent's workstation, informs the agent's treatment of a specific customer. Such a profile is separate and apparent from any profile which may exist for the user as an individual and can be completely agnostic or silent about the sentiments of the specific customer in contact with the agent.

In another embodiment, an apparatus is provided for aiding contact center agents in the management of an entity's relationships with one or more customers and/or potential customers, by reference to dynamically variable social media activities indicative of publicly expressed sentiment. The apparatus includes a computer having one or more processors, memory and at least one network interface, and further comprises a social media activity response module, including instructions executable by the one or more processors and configured to: (a) monitor social media activities by a community of users, wherein the community of users includes at least one of one or more customers of an entity; one or more customers of a competitor of the entity, one or more users of a product or service provided by the entity, or one or more users of a product or service provided by a competitor of the entity; (b) generate and store a user profile for at least some of the community of users, wherein each generated and stored user profile includes an identity of the user, and at least one of an indication of the identified user's sentiment toward the entity with respect to time, an indication of the identified user's sentiment toward a competitor of the entity with respect to time, or an indication of the identified user's sentiment toward a particular product or service offered by the entity or a competitor of the entity with respect to time; (c) schedule a communication session between a communication terminal of an assigned contact center agent and a first user for whom a user profile is stored; and (d) forward, to a display of the communication terminal of the assigned contact center agent, a menu including at least one option for addressing or capitalizing on a change of sentiment reflected in the user profile.

### BRIEF DESCRIPTION OF THE DRAWINGS

FIG. 1 is a block diagram depicting a communication system configured to aid contact center agents in the management of relationships between an entity and profiled users of social media who are customers or potential customers of the entity, according to one or more embodiments;

FIG. 2 is a flow diagram depicting a technique for aiding contact center agents in the management of relationships between an entity and profiled users of social media who are customers or potential customers of the entity, according to one or more embodiments;

FIG. 3 is a flow diagram depicting a technique for developing user profiles based on analysis of the activity and/or sentiments of a community of social media users, according to embodiments exemplified by FIGS. 1 and 2;

FIG. 4 is a screen view of a profile developed for a customer who has exhibited activity on at least one site selected for monitoring, according to one or more embodiments; and

FIG. 5 is a screen view depicting the presentation, to a contact center agent, of pre-defined responses to be offered to a customer or potential customer responsive to monitoring activity performed according to one or more embodiments.

While the method and apparatus is described herein by way of example for several embodiments and illustrative drawings, those skilled in the art will recognize that the method and apparatus for operating a contact center through detection and analysis of dynamically variable social media activity associated with profiled users is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for dynamically responding to requests and queries for information relating to one or more event invitees or attendees defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Systems and techniques for managing communications in a contact center operated on behalf of an entity and/or for managing relationships between the entity and one or more customers are described. According to one or more embodiments, a user profile is either generated and stored, or it is acquired from a third party such as the operator of one or more social networks. Each user profile corresponds to one of a plurality of social media users whose social network activity reflects interest in the entity (e.g., a “for profit” business), one or more competitors of that business, and the products or services of both or either of these. Each user profile can include the name, social network “handle” or “handles”, a customer account number, and other information specific to the user and of potential relevance to an entity in its customer relations management operations. As well, a user profile includes indications of sentiment collected over time and derived from social media event activities and/or behavior.

As used herein, “indications of sentiment” is intended to refer to any data or aggregation of data, or conclusions derived from data, from which it can be inferred that a user has formed or changed a perspective (whether to a positive, negative or neutral view) about, or is at least more willing or less willing engage with an entity, a competitor of the entity, and/or the product(s) or service(s) of an entity or its competitor(s). Drawing an inference that a user has changed perspective about, or his or her willingness to engage with, an entity, can be appropriate if, after evaluating qualitatively and/or quantitatively analyzed data to identify significant behavioral and/or articulated sentiment changes.

Explicit expressions of such sentiment can include tags, such as likes and dislikes, and the use of key words expressive of a perspective in a message, post or comment. Implicit expressions of such sentiment can include increases or decreases in a volume of social media activity. Of particular interest in one or more embodiments are shifts in sentiment. Sentiments shifts are more meaningful than absolute sentiment scores, in particular, when correlated with events/announcements/news, and the like. Correlations provide the customer relationship management with a basis for influencing customer treatment in such a way that negative shifts can be countered and positive ones can be reinforced

In the latter case, the volume of a user's social networking activity serves as a proxy for that user's perspective about an entity or his or her willingness to engage with entity.

By way of illustration, a high level of posting or commenting activity, as measured in the total number of times a user posts a message or comment to a social network sites maintained or strongly associated with the entity, is deemed by some embodiments to reflect formation of a positive perspective about the entity or at least a willingness to engage with the entity. When the aforementioned volume of activity is accompanied by a low volume of activity on the site(s) of one or more competitors, the conclusion of a positive perspective about the entity is reinforced. Conversely, if the inverse is true (i.e. high interest and/or attentiveness to one or more of a competitor's social network sites), then the positive view is presumed to relate to the competitor especially if accompanied by low interest on the entity's own social network site(s).

As proposed by the inventor herein, an additional indication of sentiment according to one or more embodiments is the identification of a relative change over time or alternatively, within predefined “event windows”. When a social media user becomes more or less attentive to the entity's social networking site(s), or more or less attentive to one or more competitors' site(s), or both (in all cases as measured by relative volumes of social media activity or changes therein), this too is treated as an indication of sentiment according to one or more embodiments. The sentiment data, according to one or more embodiments, is actionable information. In a contact center environment, the action(s) taken may be reactive, as in situations where the agent is contacted by a particular user for whom sentiment data has been acquired and analyzed. Alternatively, the actions taken may be proactive, as in situations where the contact center agent or custom relations manager is prompted to initiate contact with a particular user for whom sentiment data has been acquired and analyzed.

In some embodiments, contact center agents are prompted to deliver specific messages and/or offers to one or more profiled users. The offers are designed to address or capitalize on those sentiment shifts away from or towards, respectively, the entity. The trends may be in the aggregate, i.e., based on a macro change affecting multiple profiled users such, for example, as a negatively received product launch by a competitor, or specific to, and reflected in the social media behavior of, a particular profiled user.

Various embodiments of a method and apparatus for aiding contact center agents and others in the management of relationships with customers and potential customers are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference will now be made in detail to exemplary embodiments of the present invention, examples of which are illustrated in the accompanying drawings. Wherever possible, the same reference numbers will be used throughout the drawings to refer to the same or like parts

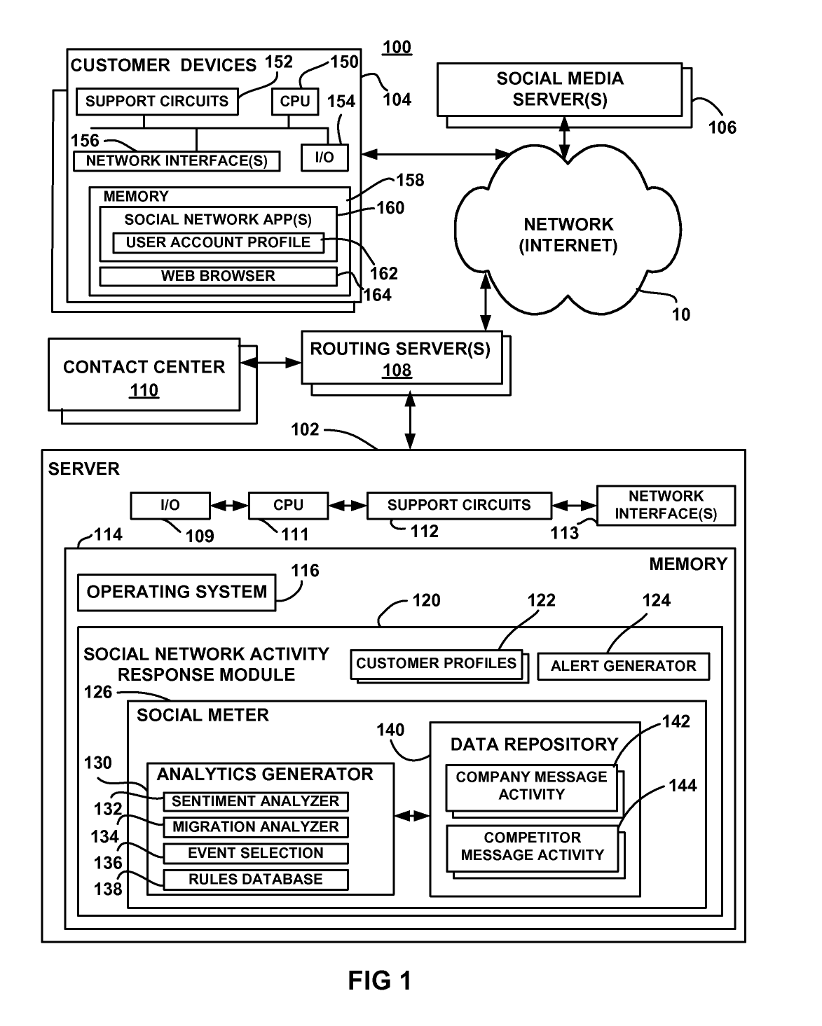

FIG. 1 is a block diagram depicting a communication system 100 configured to aid one or more entities such, for example, as a for-profit enterprise in the management of relationships with (a) one or more customers, (b) potential customers, and (c) those individuals having an influence over customers and/or potential customers. System 100 is configured to perform detection and analysis of the social network activities and/or behavior, of members of the aforementioned groups in order to build and maintain user profiles. To this end, system 100 includes a server 102, user (or customer) devices 104, one or more social networking site servers, collectively referred to as social media server(s) 106, one or more routing servers 108, and a contact center 110.

The server 102 is a computing device, for example a desktop computer, laptop, tablet computer, and the like or the server 102 may be a cloud based server e.g., a blade server, virtual machine, and the like. The server 102 includes a Central Processing Unit (CPU) 111, support circuits 112, input/output circuits 109, network interfaces 113, and a memory 114. The CPU 111 may include one or more commercially available microprocessors or microcontrollers that facilitate data processing and storage. The various support circuits 112 facilitate the operation of the CPU 111 and include one or more clock circuits, power supplies, cache, input/output circuits, and the like. The memory 114 includes at least one of Read Only Memory (ROM), Random Access Memory (RAM), disk drive storage, optical storage, removable storage and/or the like.

The memory 114 includes an operating system 116, and a Social Network Activity Response (SNAR) module 120. The operating system 116 may include various commercially known operating systems. SNAR module 120 includes a plurality of user/customer profiles 122, and an alert generator 124, and a social meter 126. Social meter 126 includes an analytics generator 130 that comprises a sentiment analyzer 132 and a migration analyzer 134, and also includes a data repository 140 that includes, records of company messaging activity 142 and competitor message activity 144 collected from such public sources as social media servers 106. According to some embodiments, each messaging activity record includes the date and time of a message transaction, the content of the corresponding message, the author of the message as, for example, a subscriber handle, and the identity of the server from which the message was extracted. According to some embodiments, the message activity records within data repository 140 include message transactions from websites such, for example, as sites where an entity or its competitors announce the launch of a new product, those where those products are reviewed, and where individuals are invited to post comments, ask questions, or provide feedback about a product.

According to some embodiments, each user or customer profile 122 includes such information as the user's first and last name, his or her telephone number, email address(es), product purchase history, and sentiment scores obtained, for example, at specific times, over periodic intervals, or responsive to a specific event. According to an embodiment, alert generator 124 is configured to respond to certain detected changes in sentiment by generating and transmitting an alerting message to a contact center agent or contact manager.

The user device 104 is a computing device, for example a desktop computer, laptop, tablet computer, Smartphone, and the like. The user device 104 includes a Central Processing Unit (CPU) 150, support circuits 152, input/output (I/O) circuits 154, network interfaces 156, and a memory 158. The CPU 150 may include one or more commercially available microprocessors or microcontrollers that facilitate data processing and storage. The various support circuits 152 facilitate the operation of the CPU 150 and include one or more clock circuits, power supplies, cache, input/output circuits, and the like. The memory 158 includes at least one of Read Only Memory (ROM), Random Access Memory (RAM), disk drive storage, optical storage, removable storage and/or the like. The memory 158 includes an operating system (not shown) that provides a computing foundation for software modules of the user device 104. The memory 158 includes one or more commercially available browsers 160 that allow the social media servers 106 to receive, authenticate and/or process message activity transactions originated by the users of customer devices 104.

The social networking site server 106 is host to a social networking site, for example, FACEBOOK, LINKEDIN, TWITTER, BEHANCE, and the like. The social media server 106 manages social interactions which include any form of social engagement. In one embodiment, social interactions include a number of likes/dislikes for a company, one of its competitors, or a product or service offered by either. In another embodiment, social interactions include stored comments for a company, competitor or product/service. In yet another embodiment, social interactions managed by social media server 106 include both a number of likes/dislikes for a company, competitor or product/service and stored comments. In still a further embodiment, social interactions are considered on a purely volumetric basis without regard to the content of any particular message. For analytical purposes, however, it is important that the social interactions include identifying information about the party who originated the social interaction.

A network 10 includes a communication system that connects computers (or devices) comprising the server 102, customer devices 104, social media servers 106, routing servers 108, and contact center 110 by wire, cable, fiber optic and/or wireless link facilitated by various types of well-known network elements, such as hubs, switches, routers, and the like. The network 108 may be a part of the Intranet using various communications infrastructure, such as Ethernet, Wi-Fi, a personal area network (PAN), a wireless PAN, Bluetooth, Near field communication, and the like.

Contact center 110 is a conventional contact center such as that offered by Avaya Inc and described in U.S. Pat. No. 6,453,038 issued on Sep. 17, 2002 and entitled SYSTEM FOR INTEGRATING AGENT DATABASE SKILLS IN CALL CENTER ARRANGEMENT, which is expressly incorporated herein by reference in its entirety. In a well known manner, contact center 110 includes one or more queues, and is configured to schedule and establish communication sessions between the respective communication terminal of a contact center agent and a customer or potential customer of an entity. According to some embodiments, system 100 is configured to initiate a communication session in response to a detected change in sentiment, as for example by notifying the agent of the sentiment change and one or more offers customized to retain the customer, win back the customer, or event divert a potential customer away from a competitor of the entity for which the agent is working. In other embodiments, contact center 110 of system 100 is configured to receive a request from one or more customers and/or potential customers to establish a communication session with an agent, and to alert the assigned agent of the sentiment status or change in sentiment. In each case, the agent or other assigned customer relationship management personnel is in a position to intervene early and with an approach customized for the user so that a relationship is preserved or gained.

Detection of changes in sentiment is formed by the analytics generator 130 of social meter 120. Analytics generator includes sentiment analyzer 132 and a migration analyzer 134. According to some embodiments, sentiment analyzer 132 accesses comments left by each user of a community of users at one or more sites of social messaging activity and indirect social messaging activity, and determines a sentiment value for each comment. Any existing technique may be used to analyze sentiment. In one example, the returned sentiment value is determined to be a value within a pre-determined range, for example −100.0 to +100.0, where a negative value represents a negative sentiment and a positive value represents a positive sentiment. In addition, the actual value represents the extremeness of a sentiment. For example, a comment that includes the word “love”, for example, “love this feature” in relation to a company product, would have a higher actual value as it is considered strongly positive and a comment that includes the word “reasonable”, for example, “reasonable performance” that is considered moderately positive.

In another embodiment, a baseline value for page visits or the like is established for each user over an initial monitoring period and, thereafter, an increase in volume to an entity's site is assigned a positive score, and a decrease is assigned a negative score. These scores are further adjusted, upward or downward, based on whether the increases come at the expense of one or more competitors (i.e. upward adjustment) or the decreases reflect a user's increased attentiveness at the site(s) of one or more competitors. The latter analysis is performed by the migration analyzer 134, which tracks the relative levels of attentiveness by measuring the volumes of user social messaging activity at sites of the entity and its competitors.

In the various embodiments of the present invention, the sentiment analyzer 132 and migration analyzer 134 are configured to support a variety of communication modes. For example, the analyzers 132 and 134 can be configured to support a client-server communication mode with one or more of direct social media channels. That is, analyzers 132 and 134 may initiate a request for information by way of a standardized message such as, a message in accordance with an API interface understood by a direct social media channel to a social media server 106 as for example, Facebook. The direct social media channel acts as a server and delivers the requested information to the analytics generator 130. However, the various embodiments are not limited in this regard and any other type of communication mode may also be used.

Further, according to an embodiment of the present invention, the analytics generator includes an event selection module 136, and a rules database 138. The event selection module 136 is configured to enable system users to identify sites that they want to have tracked by the event selection system. For example, a Facebook page owner may identify their own Facebook page, plus the Facebook pages of certain competitors where product launches, discontinuations, recalls, bug fixes and the like may be announced to the public. In an embodiment of the present invention, the event selection module 136 allows users to identify certain Facebook pages and then migration analyzer 134 tracks the social media users that visit those Facebook pages. The tracking performed by migration analyzer 134 can include observing how the social media users interact with each identified Facebook page, how they cross over from page-to-page, and so forth.

Further, the migration analyzer 136 is configured to monitor predetermined activities of a social media user. In an embodiment of the present invention, the migration analyzer 134 is configured to continuously monitor for predetermined activities that the social media user conducts while visiting a social networking site, in particular one or more predetermined business or personal Facebook pages, which may be grouped into a configurable set of Facebook pages (“Page mix”). Predetermined activities may include posting of messages (i.e., posts), comments (e.g., responses to other posts), likes or dislikes, posting or viewing of photos, tags (i.e., identification of a person in a photo), and substantially any other publicly visible user and/or page-owner expressions.

The Page mix may contain a link to the social media or social media channels of a business's known competitors' pages, and a link to Facebook pages of other businesses (e.g., competitors, suppliers, customers, peers, etc.). An activity recorder records new activities and adds the new activities to a repository of activities that may be searched by either Page ID or activity owner ID.

In another embodiment of the present invention, the sentiment analyzer 132 may determine a dynamic Page mix for a customer profile under the direction of the system user. A dynamic Page mix may include additional pages that social media user who have been active on an initially determined static core Page mix may have also been active on. For example, if a system user represents company ‘A’, the core Page mix may include all of A's Facebook pages. For each social media user who has been active on these pages, the event selection system would determine and track which other page(s) the social media user interacted with and add those pages to the Page mix. Further, sentiment analyzer 132 may monitor social media users' behavior across different Facebook pages, with pages to monitor being identified in advance to monitor temporal closeness of social media users' actions. The temporal closeness of social media users' actions may indicate that actions that take place close in time are more significant for the system user than if they take place farther apart in time. For example, public Facebook pages identified for monitoring are linked in some sense, for example, pages for Company ‘X’ that has competition ‘Y’ and ‘Z’, or a set of different Facebook pages each tailored to a different demographic, different geography, or the like. Further, suppose an owner of the pages wants to track how a social media user behaves across these public Facebook pages such as a company may want to measure itself against a competitor in some way, or monitor how often social media user jumps back and forth between the company pages and the competitor's pages.

Further, the sentiment analyzer 134 is configured to monitor temporal aspects of the social media users' viewing across the monitored pages. In an embodiment of the present invention, temporal aspects of the social media users' may be monitored by way of a relative time stamp. The relative time stamp indicates the elapsed time between observable events on monitored social media channels. The observable events may include posting a comment, replying to a comment, tagging, liking, disliking, etc. Furthermore, the sentiment analyzer 134 is configured to mine social media user related data from social media channel. In an embodiment of the present invention, a primary source for collecting the social media data may be via application programming interface (API) functions available from a social media server 106 such as in Facebook.

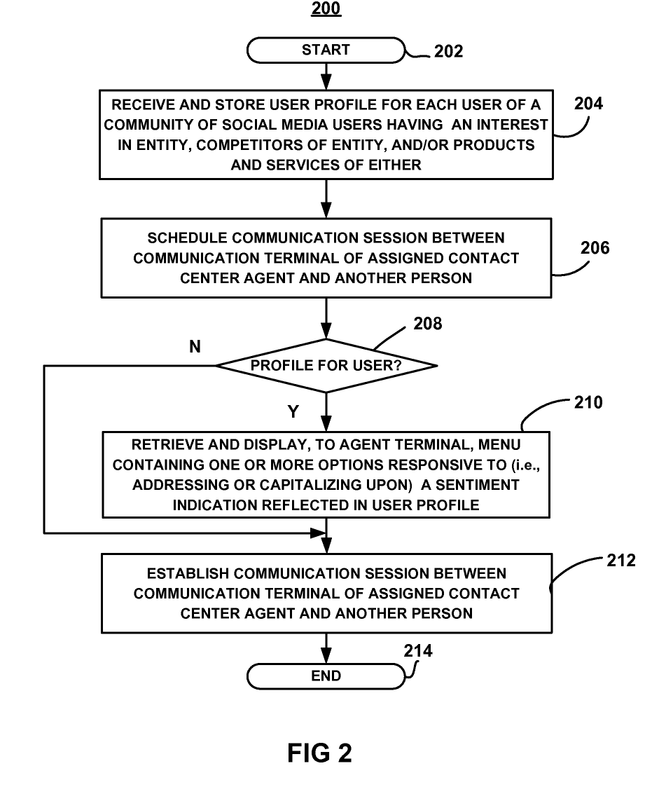

FIG. 2 is a flow diagram depicting a technique for aiding contact center agents in the management of relationships between an entity and profiled users, of one or more social media networks, who are customers or potential customers of the entity, according to one or more embodiments. The method 200 starts at step 202 and proceeds to step 204. At step 204 the method receives and stores a user profile for each user of a community of social media users having an interest in an entity, in one or more competitors of the entity, and/or in the products or services of the entity or its competitor(s).

The process proceeds to step 206. At step 206, a communication session is scheduled at a contact center between the communication terminal of an assigned contact center agent and one of the profiled users of the community of users. In this regard, at least two discrete scenarios are contemplated. In a first scenario, a party contacts the contact center by, for example, dialing a telephone number for customer service or by accepting a “chat” invitation via the web portal of the entity on whose behalf a contact center is operated. In accordance with such embodiments, a determination is made at step 208 as to whether a profile is available for the user initiating the communication session. If so, then at step 210, in addition to any other pertinent data from the party's profile needed by the assigned agent for the session, one or more options responsive to the sentiment profile reflected in the profile are displayed to the agent. The communication session is then established between agent and contacting party at step 212 and thereafter terminates at step 214.

By way of illustrative example, if the profile of the contacting party reflects sentiment and/or migration analysis which shows that the contacting party has traditionally been a loyal customer of a competitor of the entity, and that the contacting party has recently been interested in the products and/or services of the entity, then the agent may be prompted at step 210 to offer the contacting party a specific discount or special offer. Likewise, if the contacting party has traditionally been a loyal customer of the entity, but has recently been showing signs, on a volumetric basis, of being less attentive to the entity's own brand and product messages and more attentive to those of the competitor, such a discount or offer may also be made, and the communication session may be handled on a more expedited basis (e.g., diverted to a priority queue in which calls are routed to an agent with special dispatch as compared to other calls which may merely be forwarded to an agent in the order in which they are received).

In an alternate embodiment, it is the contact center and not a customer or potential customer who initiates the scheduling of a communication session. In such a scenario, a shift in sentiment adverse to the entity or one of its competitors may have already been identified as, for example, through recent performance of sentiment and/or migration analysis in accordance with one or more embodiments. Alternatively, regular calls to customers and/or potential customers are scheduled as part of a regular customer relations management program. In either case, a profile for the customer/potential customer is presumed and therefore step 208 is bypassed. At step 210 details of the profile are presented to the contact center agent or customer relations manager. If the profile reflects a shift in customer sentiment, then as before, the agent or relationship manager is presented with one or more options designed to overcome a possible customer “flight risk” or to deepen a relationship with a customer who has shown signs of being more interested in the products or services of the entity and less so in those of a competitor of the entity. In this way, pro-active steps can be taken to win over a customer within a window of opportunity where the sentiment against the competitor is at a historic maximum. Steps 212 and 214 are performed in the same manner as already discussed in connection with the first scenario.

The sentiment data, according to one or more embodiments, is thus actionable information. In a contact center environment, the action(s) taken may be reactive, as in situations where the agent is contacted by a particular user for whom sentiment data has been acquired and analyzed. Alternatively, the actions taken may be proactive, as in situations where the contact center agent or custom relations manager is prompted to initiate contact with a particular user for whom sentiment data has been acquired and analyzed.

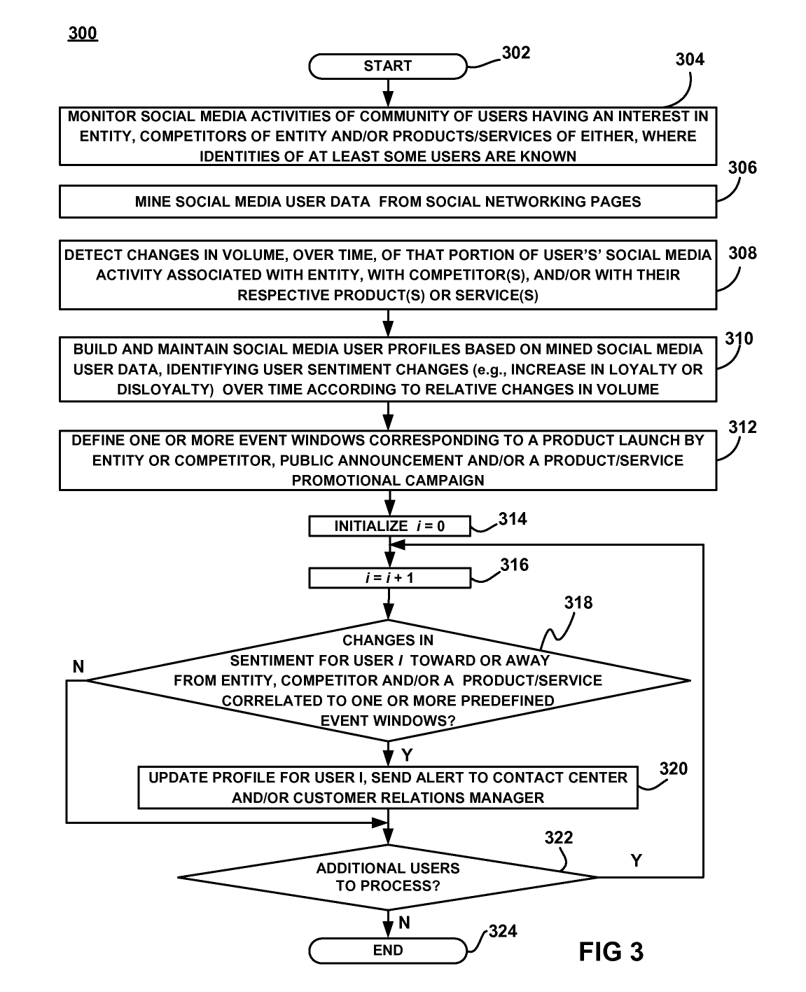

FIG. 3 is a flow diagram depicting a method 300 for developing user profiles based on analysis of the activity and/or sentiments of a community of social media users, according to the embodiments exemplified by FIGS. 1 and 2. The method starts at step 302 and proceeds to step 304. At step 304, the method 300 monitors social media activities of a community of users having an interest in an entity, one or more competitor(s) of an entity, and/or the products and/or services of the entity or its competitor(s). The community includes but is not limited to customers of the entity, and customers of competitors, and persons who exert influence over each of them. According to some embodiments, the identities of the users are known and details about them, such as their names, account numbers, email addresses and phone numbers, and social media “handles” are known. However, in some embodiments, data is gathered for one or more users even if nothing more than their social media handle(s) are known, on the expectation that more detailed identifying data may become available in the future.

The method 300 proceeds to step 306, where social media user data is mined from social network media channels such as Facebook or LinkedIn pages. The method then proceeds to step 308, where the method detects changes in volume, over time, in that portion of users' social media activity associated with the entity of interest, its competitor(s), and the products of either or both of these. The method 300 proceeds to step 310.

At step 310, method 300 builds and maintains social media user profiles based on mined social media user data, identifying user sentiment changes defined, for example, as changes over time in loyalty or disloyalty to the entity and/or its competitors, or with respect to the products and/or services of these. At step 312, the method 300 defines one or more event windows corresponding to a product launch by the entity or one of its competitors, a public announcement by either of them, and/or a campaign promoting a product or service of either of them. This can be done manually, for example by a user of system 100 having knowledge of the nature and date of a specific announcement to the user community via a social media channel. In such embodiments, a window of m minutes, hours, days, or weeks, may be selected by the user of system 100, where m is a user-selectable positive number greater than zero measured from the occurrence of the event. Alternatively, every announcement can automatically be characterized as an event and the window m is set to a default value. For purposes of analysis and processing according to one or more embodiments, a measurable change in sentiment, as defined by a sentiment score corresponding to relative volumetric change(s) in user social messaging activity and/or ratings derived from words and phrases within a user's messages, which occurs within the event window is deemed to be attributable to the event.

With the social media user profiles thus constructed, they may be analyzed to enhance the customer relations management operations of a contact center in accordance with one or more embodiments. To this end, the method 300 proceeds to step 314, wherein an initialization is performed prior to analyzing the profile of each user. At step 316, the user profile ID i is incremented by one. The method 300 then proceeds to determination step 316, where the method determines if a change in sentiment by user i toward or away from the entity, its competitor(s), and/or their products/services falls within an event window. If so, then the method 300 updates the profile for user i at step 320, and then generates and sends an alerting message to a contact agent or person responsible for managing the relationship between the entity and the user i. If not, or following the sending of the message, the method 300 proceeds to step 322, where it is determined whether there are any other user profiles to be analyzed. If so, the method returns to step 316 and processes the next user profile. Otherwise, the method terminates at step 324.

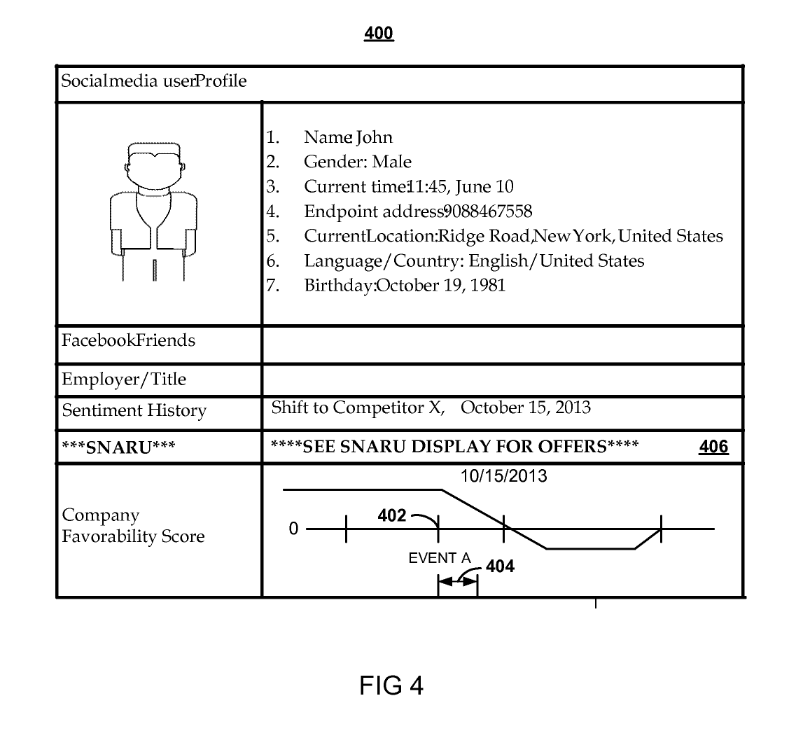

FIG. 4 is a screen view of a profile 400 developed for a customer who has exhibited activity on at least one site selected for monitoring, according to one or more embodiments. The profile includes such information as the name of the user, the gender, an endpoint address such, for example as an email address, telephone number, or IP address, a primary language of the user, and other information of interest. According to an embodiment, the profile 400 also includes a timeline showing changes in the customer's sentiment score with respect to time, with an indication of any specific events, such as Event A indicated at reference numeral 402. An event window 404 is associated with Event A and is correlated to a downward trend in a measure of user sentiment known as the company favorability score. Recalling the methods exemplified by the embodiments of FIGS. 2 and 3, a proactive response to the negative turn in sentiment commencing with Event A would be to generate a pop-up display on the terminal of a contact center agent, and highlight the availability of one or more options which might be offered to the user to prevent a defection to a competitor. In FIG. 4, the availability of such an option is represented by reference numeral 406, which prompts the user to pull up a display o of available options. Although not shown in FIG. 4, some embodiments would include similar favorability scores for one or more competitors so that at a glance the agent or other customer relationship manager can evaluate the risk of a customer defection and select an offer tailored to the exigencies of a given situation. For example, if a user has not only exhibited signs of a recent drop in attentiveness to the company's social network channels and product messaging, and this drop is paired with a rise in attentiveness to messaging by a competitor, the most attractive offer might be selected and offered to the customer without delay.

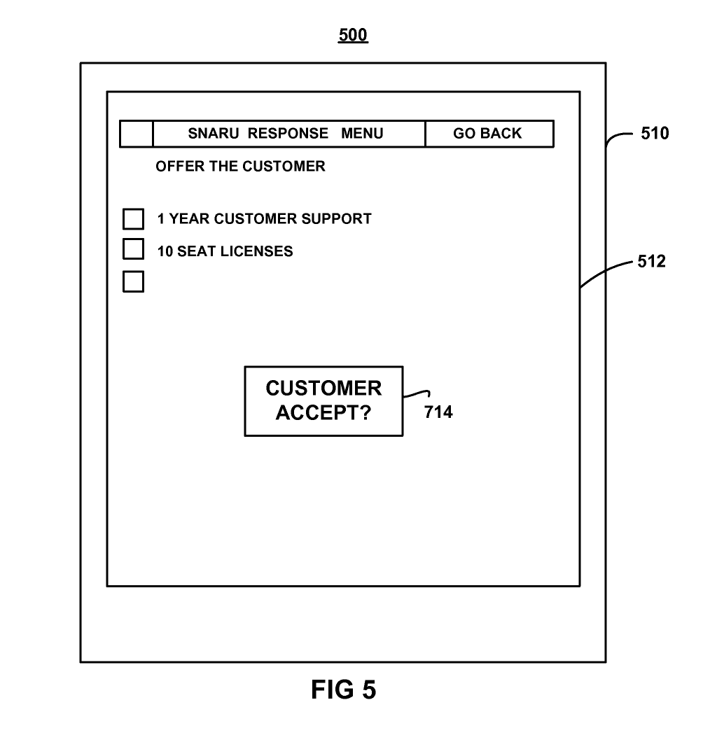

FIG. 5 is a screen shot depicting a user interface 500, displayed on a contact center agent's communication terminal, and obtained by execution of a sentiment/migration analysis client program by a processor, according to one or more embodiments. Continuing with the example discussed in connection with FIG. 4, the agent pulling up the SNARU display 406 would view, on the display 510 of his or her contact center communication terminal, a user interface 512 identifying several offers of probable interest to the customer (based on prior purchase history, messaging activity and the like). A soft button 714 enables the agent to indicate whether the customer accepts the offer, in which case a specialized ordering process would be invoked.

Although embodiments described above have been with reference to profiles relating to sentiment and generated for individuals based on qualitative and quantitative analysis of the social network activity of a community of users, there is also applicability to the generation and use of profiles developed at the group or sub-group level. In some embodiments, for example, the social media activities of one or more entire customer subpopulation(s) are analyzed during a given timeframe. Such analysis can be in furtherance of the purpose of improving/strengthening relationships with customers or prospective customers. In some embodiments, an entire subpopulation receives a “profile”, and the profile contains information which when viewed at the display of a contact center agent's workstation, informs the agent's treatment of a specific customer. Such a profile is separate and apparent from any profile which may exist for the user as an individual and can be completely agnostic or silent about the sentiments of the specific customer in contact with the agent. For example, the subpopulation might be all U.S., female, college-educated Acme customers who posted on Acme's Facebook page in the last 90 days. If an analysis of this subpopulation's activities on Acme's and Acme's main competitor's Facebook pages correlates a sudden spike in activity on the competitor's page after Acme announced major layoffs of female managers, Acme's agents might want to respond to posts from this subpopulation a little differently than before the announcement, regardless of how the individual posters feel about Acme.

The embodiments of the present invention may be embodied as methods, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method for managing communications in a contact center, comprising:
monitoring social media activities by a community of users, wherein the community of users includes at least one of
one or more customers of an entity;
one or more customers of a competitor of the entity;
one or more users of a product or service provided by the entity; or
one or more users of a product or service provided by a competitor of the entity;
by a processor, automatically generating and storing a user profile for at least some of the community of users, wherein each generated and stored user profile includes an identity of the user, and at least one of
an indication of the identified user's sentiment toward the entity at one or more points in time;
an indication of the identified user's sentiment toward a competitor of the entity at one or more points in time; or
an indication of the identified user's sentiment toward a particular product or service offered by the entity or a competitor of the entity at one or more points in time;
establishing a communication session between a communication terminal of an assigned contact center agent and a first user for whom a user profile is stored; and
retrieving and displaying, to a display of the communication terminal of the assigned contact center agent, a menu including at least one option for addressing or capitalizing on a change of sentiment reflected in the user profile.

2. The method according to claim 1, wherein the monitored social media activities includes at least one of posts, comments, likes, or tags expressed by users of the community of users via one or more social network channels.

3. The method according to claim 1, wherein the establishing is responsive to a request received by a communication from the first user.

4. The method according to claim 3, wherein the request is submitted by a message posted to a social network page of the entity.

5. The method according to claim 4, wherein the established communication session includes a reply message posted to a social network page of the entity or to a social network page of the first user.

6. The method according to claim 3, wherein the request is for an interactive voice communication session

7. The method according to claim 1, further including identifying, based on the monitoring, at least one shift in at least one of:
sentiment toward or away from the entity;
sentiment toward or away from a competitor of the entity;
sentiment toward or away from a product or service offered by the entity; or
sentiment toward or away from a product or service offered by a competitor of the entity; and
correlating, by execution of instructions using a processor, the shift to at least one of a plurality of stored, predefined event windows.

8. The method according to claim 7, wherein each event window corresponds to a product or service launch by the entity or a competitor of the entity, a public announcement by the entity or a competitor of the entity, or launch of a promotional campaign by the entity or a competitor of the entity.

9. The method according to claim 7, further including a step of generating and transmitting an alerting message responsive to identification of a shift.

10. The method according to claim 1, wherein the monitoring comprises:
determining, during at least one monitoring window, a quantity of social media activity events accessible via the internet and identifying both a user of the community of users and at least one of the entity or a competitor of the entity.

11. The method according to claim 10, wherein social media activity events include messages, posts, comments, or tags used for expression of sentiment by users of the community of users.

12. The method according to claim 10, wherein the generating includes
assigning a time varying score to at least one of the entity or the at least one competitor of the entity, based on the volume of social media activity with respect to time during the monitoring window.

13. An apparatus comprising:
a computer having one or more processors, memory and at least one network interface, and further comprising:
a social media activity response module, including instructions executable by the one or more processors and configured to:
monitor social media activities by a community of users, wherein the community of users includes at least one of
one or more customers of an entity;
one or more customers of a competitor of the entity;
one or more user of a product or service provided by the entity; or
one or more user of a product or service provided by a competitor of the entity;
generate and store a user profile for at least some of the community of users, wherein each generated and stored user profile includes an identity of the user, and at least one of
an indication of the identified user's sentiment toward the entity at one or more points in time;
an indication of the identified user's sentiment toward a competitor of the entity at one or more points in time; or
an indication of the identified user's sentiment toward a particular product or service offered by the entity or a competitor of the entity at one or more points in time;
establish a communication session between a communication terminal of an assigned contact center agent and a first user for whom a user profile is stored; and
forward, to a display of the communication terminal of the assigned contact center agent, a menu including at least one option for addressing or capitalizing on a change of sentiment reflected in the user profile.

14. A computer implemented method for managing communications in a contact center operated on behalf of an entity, comprising:
receiving and storing a user profile for a community of social media users, wherein each respective generated and stored user profile includes
an identity of a corresponding user of the community of social media users, and
an indication of sentiment derived from social media event activities, the indication of sentiment including at least one of
an indication of the corresponding user's sentiment toward the entity at one or more points in time;
an indication of the corresponding user's sentiment toward a competitor of the entity at one or more points in time; or
an indication of the corresponding user's sentiment toward a particular product or service offered by the entity or a competitor of the entity at one or more points in time;
scheduling a communication session between a communication terminal of an assigned contact center agent and a first user for whom a user profile is stored; and
retrieving and displaying, to a display of the communication terminal of the assigned contact center agent, a menu including at least one option for addressing or capitalizing on a change of sentiment reflected in the user profile.

15. The method according to claim 14, wherein social media activity events from which sentiment indications are derived include messages, posts, comments, or tags used for expression of sentiment by users of the community of users.

16. The method according to claim 14, wherein each corresponding user profile includes a time varying score assigned to at least one of the entity or the at least one competitor of the entity, based on a monitored volume of social media activity with respect to time during a monitoring window.

17. The method according to claim 14, further including establishing a communication session between a communication terminal of an assigned contact center agent and a first user for whom a user profile is stored.

18. The method according to claim 17, wherein establishing the communication session includes setting up an interactive voice communication session between the assigned agent and the user.
